(19) United States
(12) Patent Application Publication
(10) Pub. No.: US 2007/0138222 A1
(43) Pub. Date: Jun. 21, 2007

(54) Readily deployed and stowed storage devices for temporary holding and transporting personal items

(75) Inventor: Ira H. Goldman, Washington, DC (US)

Correspondence Address: IRA H. GOLDMAN, 1816 KILBOURNE PLACE, NW, WASHINGTON, DC, 20010, US

(73) Assignee: Ira H. Goldman, Washington, DC (US)

(21) Appl. No.: 11/566,683

(22) Filed: Dec. 4, 2006

Related U.S. Application Data
(60) Provisional application No. 60/742,193, filed on Dec. 2, 2005.

(51) Int. Cl. B65D 30/00; B65D 33/14; A45C 13/40; B60R 9/00; A45C 15/00; A45C 3/00; A45C 3/06; A45C 1/02; B60R 7/00

(52) U.S. Cl. 224/401; 383/4; 383/24; 150/106; 190/111; 150/112

(57) ABSTRACT

Disclosed are small, compact devices that provide readily deployed storage for small personal items, and they can also readily be returned to their stowed configuration. This toggling between deployed and stowed can be accomplished without a required change to the connection of any such device to another object, such as a travel case. The devices provide specific benefit to people going through an airport or building security checkpoint at which it is a requirement that pocket items such as cell phones, keys, and coins must be removed from one's pockets for assessment by a scanning apparatus.

### CROSS-REFERENCE TO RELATED APPLICATION

This application claims the benefit of U.S. provisional application Ser. No. 60/742,193, filed on Dec. 2, 2005, the entire content of which is hereby incorporated herein by reference.

### FIELD OF INVENTION

The invention relates to readily deployed and stowed storage devices for temporary holding and transporting of personal items, especially when a person and the person's personal property are being screened at a security checkpoint.

### BACKGROUND OF THE INVENTION

People often find themselves with too many things to carry at once. This is true for travelers using commercial transport who take with them carry-on luggage. It is also true for those who carry briefcases and rolling travel cases during their trips to and from work, as well as to business meetings or, for lawyers, to court appearances.

When people are required to go through a security checkpoint at the airport, at a government building, or at certain commercial buildings, getting such travel cases and myriad metal pocket items processed at the checkpoint is time consuming, and it can sometimes lead to the pocket items being unintentionally left behind at the checkpoint.

The invention of this application addresses these and related problems.

The invention provides convenient, closable storage devices of adequate size to carry typical pocket items, such as keys, coins, cell phones, music playback devices, text-messaging devices, watches, and wallets, that need to scanned at security checkpoints.

These storage devices are collapsible, and in their collapsed state they can be unobtrusively attached to a travel case. For example, certain embodiments of the invention can be attached and be left attached to a piece of luggage just as would a luggage ID tag. When in their collapsed state, these embodiments are generally comparable in size and weight to such an ID tag. Yet, they can be quickly deployed, used for temporary storage, and then collapsed again.

For use at a security checkpoint, the devices are designed to be deployed, filled with pocket items, closed, and then sent through the security scanner along with the travel case. At the exit end of the scanner machine, the device and its contents can be readily retrieved with the travel case, and the items stored within the device may be removed and placed back in one's pockets there or at some later time and place of convenience.

Storage devices are known which attach to travel cases in order to carry additional items, even while such cases are sent through a scanner machine, yet those devices lack certain attributes, such as not being formed to allow them to be readily collapsed or to be collapsed such that they are compact and unobtrusive in size and appearance.

Numerous collapsible bags are known. Some are made of thick, heavy materials, such as canvas, and are designed to be folded. Others are made of lightweight nylon so that they may be compacted into a very small size, often by stuffing them into an accompanying, small stuff sack. Yet, the designs of such bags generally do not allow them to be attached to a travel case in a collapsed state and, while still so attached, be expanded for advantageous use as described in this application.

One bag has been proposed to allow collapsing and expanding while attached to a travel case, but its design does not allow it to be collapsed to and maintained in an unobtrusive size. Similarly, bags have also been disclosed in other fields which might seem adaptable to the advantageous use described here, but they also are too large even when collapsed. Just as a proper structural design for a 50 story building is not simply an upsized design for a 10 story building, at some point a change in size from a large device to small one entails more than simply a change in dimensions of constituent components.

Because of the small size of the pouches of the present invention, as well as features allowing embodiments to be quickly and easily deployed and re-collapsed, and in between having items quickly stored in and retrieved from it, dynamics come into play that are different from those affecting the design of larger bags. For example, larger items of a given thickness can be folded more times than can smaller items of the same thickness, as shown by research undertaken by Britney Gallivan. While her work was performed for a high school project, it has been widely cited. From her work, she derived the following formula: L=((π*t)/6)*(2ⁿ+4)*(2ⁿ−1), where L is the minimum possible length of the material, t is the material's thickness, and n is the number of folds possible in one direction.

Assuming that folding a large pouch and a small pouch the same number of times and according to the same pattern generates identical increases for each in the aggregate thickness of the folded material, through often this is not correct, relative to each pouch's height and width the thickness of the small pouch can be much greater. So, to minimize the actual and perceived thickness of a small pouch when it is collapsed, a small pouch's design must incorporate different construction features. For example, while some devices disclosed elsewhere utilize substantial stiffener components in each of a their folding sections, those embodiments of the present invention that utilize stiffeners utilize modest, foldable ones.

The number of times and the direction in which a device is folded to minimize its size when in its collapsed state also affects the design of the systems used to attach it to a travel case, construction methods and components used to make the device easy to deploy and collapse, and particularly the materials used to make the pouch component of the device. For example, a device that simply folds or rolls up and down to move to and from its deployed and collapsed states can entail different attachment strap design challenges than does a device which folds up and down as well as side to side. Collapsing the latter device entails compound folds—layers of material folded over each other in one direction which are then folded in another direction—while that is not true for the former bag. Additionally, it can be more difficult to neatly fold a device which uses compound folds, and as suggested above this is especially true as the device becomes smaller in size.

The present invention can be advantageously practiced using extremely lightweight material for constructing its pouch component. For example, the pouch of the invention can be constructed of nylon fabric weighing less than 45 grams per square meter, and the total weight of the embodiment can be as little as 30 grams.

While lightweight nylon and comparable materials are generally not regarded as being stiff, when used to make a device of the invention appropriate sized for many situations, often smaller than 14 centimeters square, the pouch of the invention can be constructed to be stiff enough without a full complement of stiffeners to be folded in a geometric pattern readily and quickly, even using only one hand and while the device is dangling from a piece of luggage.

Another design challenge for a storage device which collapses to a very small size and which also must serve the purposes of the present invention is that the pouch opening must be of at least a certain minimum size so that the user can place his hand into the bag to retrieve his items. Based on an analysis of glove industry data, the practical minimum opening size of a slit-style opening is approximately 5.25″, which would nevertheless make it somewhat difficult for someone with a large hand and basically impossible for someone with an XL hand size to reach into the pouch. Unless the pouch is designed to be folded side to side, the collapsed size of the bag would necessarily be substantially larger than the collapsed size of the devices of the invention.

### OBJECTS

It is an object of the invention to make it easier and more efficient for individuals to be processed with their personal items through a security checkpoint.

It is also an object of the invention to provide individuals with a device to hold their pocket items and other personal items when such items are to be submitted for scanning, scanned, and then retrieved.

It is also an object of the invention to provide to individuals such a device that is easy to quickly deploy, place items therein, retrieve items therefrom, collapse, and secure in a collapsed state.

It is also an object of the invention that such device be lightweight, small, and compact when it is in its collapsed state.

### GENERAL DESCRIPTION OF SELECT FEATURES OF THE INVENTION

A number of novel elements of the invention are available for incorporation into select embodiments of the invention to help them meet objects of the invention.

The choice and use of closure mechanisms for the storage pouch in devices of the invention depend not simply on the effectiveness of a given such mechanism. Rather, they also are based on the goal of promoting minimization of size of the devices when they are collapsed. For collapsible storage devices in which the pouch and its closure mechanism are folded along vertical axes, a portion of the closure mechanism is typically folded upon itself. Since the closure mechanism can be the thickest component of the device, design features which reduce such over-folding can reduce the finished thickness of the collapsed device.

Related-art collapsible storage devices are constructed with the opening of their storage volume between their front and back walls at the top and a closure mechanism incorporated as a means to close that opening.

Such storage devices which utilize a zipper for that function do so with the zipper's planar surfaces oriented horizontally. This makes compact folding of such a device side-to-side troublesome as a zipper can best be folded compactly when its planar surfaces are brought against each other in a face-to-face fold and for these zippers that would generally entail a lateral folding. The devices of the invention that are constructed to be folded geometrically side-to-side and that utilize a zipper orient the zipper so that it will be folded in a face-to-face fashion, though actual face-to-face contact is often minimized. This is generally accomplished by forming the opening and installing the zipper in the front wall near its top edge.

For a top-opening storage device that uses a hook-and-loop closure mechanism, such as the brand-name product Velcro®, the design challenge is different. While such a closure mechanism is typically incorporated in a way that a side-to-side fold of the device would cause an acceptable face-to-face folding of the closure mechanism, such closure mechanisms are relatively thick and therefore present a special design challenge when crafting a device that collapses to a very small size. One novel approach of the invention comprises installing this type of closure mechanism in an offset pattern so that there is a reduction in the amount of overfolding. Another novel approach of the invention for reducing the total thickness of a collapsible storage device is to set this type of closure mechanism at a bias. This approach also works with other closure mechanisms, including continuous mechanisms such as zippers and zipper-like mechanisms used with food storage bags and the like. Or, if the closure mechanism is set at a regular angle, folding at an irregular angle can achieve the same beneficial result.

Additionally, minimization of the thickness of the collapsed device of the invention is aided in some embodiments by constructing the device to minimize the total thickness of material sandwiched with the thickest part of the closure mechanism. One approach of the invention comprises irregular folding patterns, such as when a zipper will be divided by folding into two segments, arranging the construction so that the division, rather than being 50-50, favors the side on which the slider is present so that the slider will overshoot the opposite end of the zipper and come to rest on a non-zipper element of the device.

For embodiments of the invention that comprise folding the device side-to-side to collapse it, placement of the strap or straps which connect the device to a travel case entails additional challenges. For example, affixing an attachment strap system at a location on the device that appropriately balances the pouch when the pouch is holding items can result in the collapsed device looking obtrusive, such as in a bottom-heavy T-shape. The invention discloses devices that provide appropriate balance for the pouch when in use yet an advantageous presentation of the device when it is collapsed.

Some device embodiments of the invention that comprise side-to-side folding teach a novel design whereby the strap system is splayed at the cover of the device when the device is deployed but is unified when the device is collapsed. Related art teaches the use of splayed or spread-apart straps to meet balance concerns for a container device when it is carrying items, but because their strap arrangement are generally unchanged when the device is collapsed, they offer a disadvantageous opening created by such straps and the body of the device that can easily be snagged along the way.

### BRIEF DESCRIPTIONS OF THE DRAWINGS

FIGS. 1-1D show a preferred embodiment of the invention that is a folding pouch with a tri-fold cover and a strap for engaging a luggage handle.

FIG. 1E shows a clip, an alternative to the strap, for attaching the device to a pants belt.

FIGS. 2-2E show views of a folding device with an offset zipper and bottom-up roll cover.

FIGS. 3-3C show views of a stuff pouch with bottom-opening case.

FIGS. 4-4A show views of a stuff pouch with a thin material stuff case.

FIGS. 5-5E show views of a folding device with an offset zipper and side-roll cover.

FIGS. 6-6C show views of a unified material folding device with ID card in a wallet-shaped form.

FIGS. 7-7D show views of a folding device with offset zipper, diamond-shaped cover, and ID card.

FIGS. 8-8B show views of a folding device with offset hook-and-loop strips and a rigid plastic case.

FIG. 9 shows a view of an deployed folding device, standing alone, comprising alternative approaches to avoiding folding over the zipper slide.

FIGS. 10-10C shows views of a collapsible pouch with zippered case integrated with a rolling suitcase.

FIGS. 11-11B show views of a swing-out collapsible pouch with panel cover integrated with a rolling suitcase.

FIGS. 12-12C show views of a unified nylon folding pouch with offset hook-and-loop strips.

### DETAILED DESCRIPTION OF PREFERRED EMBODIMENTS

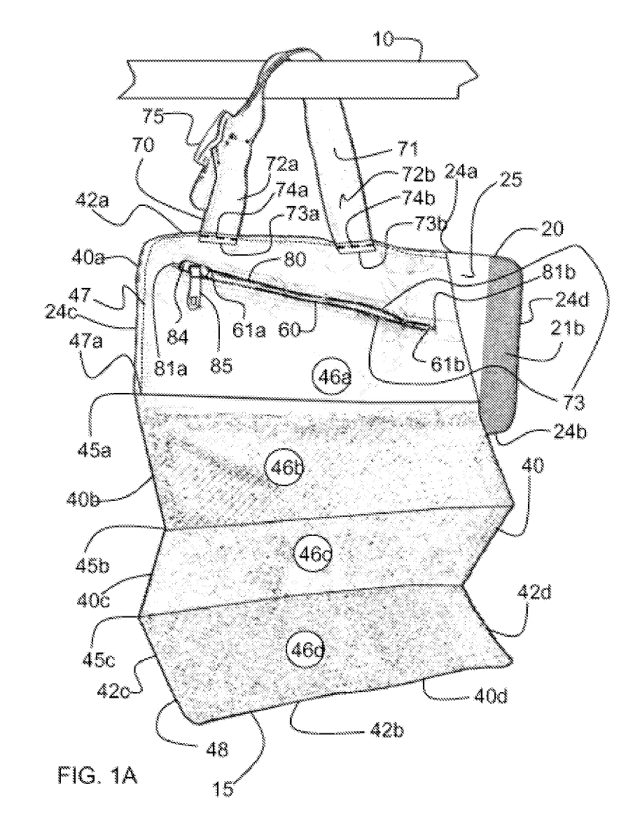

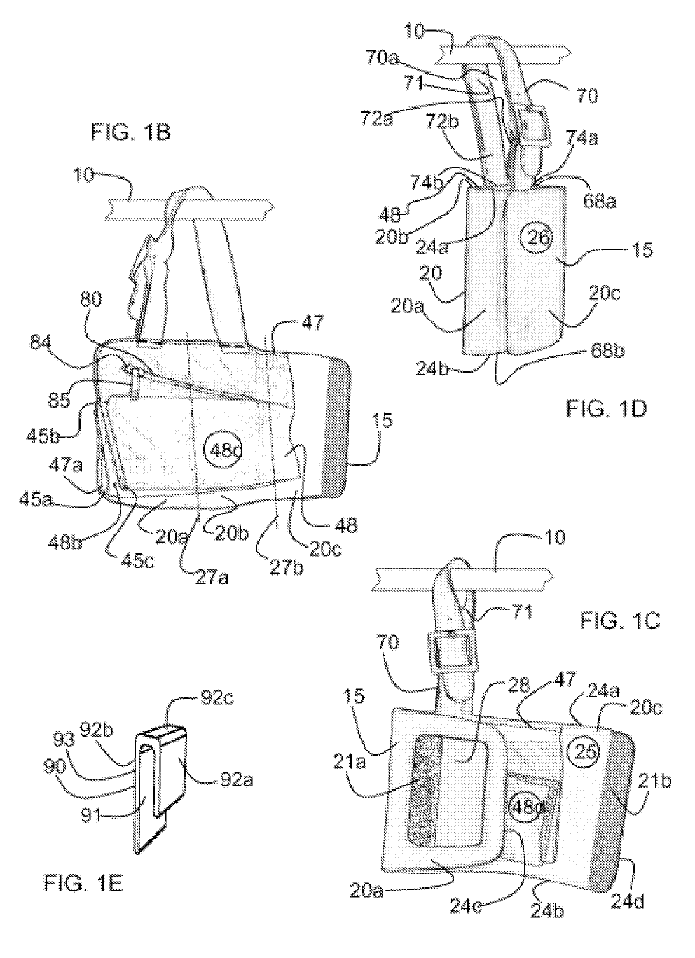

FIGS. 1-1D show a folding pouch with a tri-fold cover and a strap for engaging a luggage handle, a preferred embodiment of the invention.

A storage device 15 is shown which comprises a cover mechanism 20 and a pouch 40.

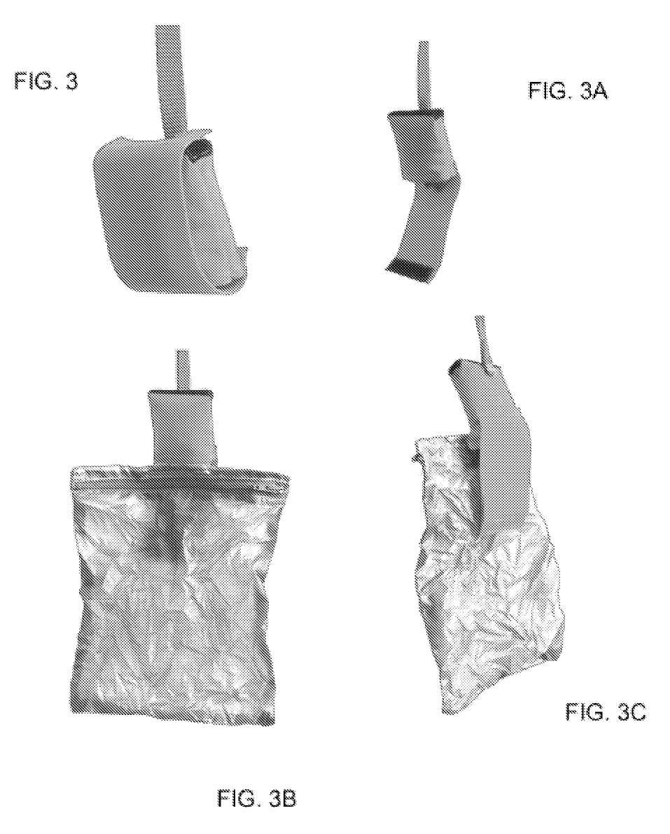

The cover mechanism comprises a left section 20a, a middle section 20b, and a right section 20c, a fastener-a 21a, shown in FIG. 3, which cooperates with a fastener-b 21b to keep the cover closed. The cover mechanism further comprises an upper edge 24a, a lower edge 24b, an edge left 24c, an edge right 24d, as well as an inside 25 and an outside 26.

The cover mechanism additionally comprises a strap 70 which facilitates a secure engagement of the storage device with handle 10 through a strap void 70a. In order to engage the handle, the strap can be made temporarily discontinuous by means of a buckle 75. The strap comprises a first strap end 73a and a second strap end 73b, as well as an inner surface 71, which comprises a first surface 72a and a second surface 72b.

The strap is affixed to the cover mechanism, being joined at the and the first and second strap ends of the strap to a first location 74a and a second location 74b, respectively, of the cover proximate its upper edge 24a.

The cover further comprises a window 28 through which an ID card, if inserted behind said window in a card-holding structure (not shown), can be seen.

Pouch 40 comprises a front wall 46, a back wall 48, an opening 60, and a zipper 80. It further comprises a top segment 40a, a mid-top segment 40b, a mid-lower segment 40c, and a lower segment 40d, interspersed with a top crease 45a, a middle crease 45b, a bottom crease 45c. Pouch 40 also comprises a top edge 42a, a bottom edge 42b, a left edge 42c, and a right edge 42d.

Additionally, pouch 40 comprises a seam 47, which affixes the pouch to the cover mechanism, and a pivot point 47a which can aid the folding of the pouch, namely mid-top segment 40b to top segment 40a.

Front wall 46 comprises a top front wall segment 46a, a mid-top front wall segment 46b, a mid-lower front wall segment 46c, and a lower front wall segment 46d, while back wall 48 comprises a back wall mid-top segment 48b and a back wall lower segment 48d. Wall segments 46c-d and a majority of wall segment 46b is constructed from a see-through mesh material, making it easier to visually inspect personal items in the pouch and for the person suing the pouch to more easily discern that all items have been removed from it.

Opening 60 comprises a first end 61a and a second end 61b.

Zipper 80 comprises an opened end 81a, a closed end 81b, a teeth component 83, a slider 84, and a pull 85.

As shown in FIG. 1A, device 15 is shown substantially deployed with pouch 40 substantially unfolded, but slightly folded in order to highlight fold structures of the pouch and related structures.

When device 15 is deployed compared to when it is stowed, strap ends 73a-b are splayed rather than in a unified arrangement and strap surfaces 72a-b are both facing forward rather than being opposed. This splaying is arranged by opening the cover mechanism which remains unified, without portions of the cover being split off from one another. This splaying can provide both actual and perceived stability for device 15 when it is in use holding a number of personal items.

The creases 45a-c make it easy to quickly fold pouch 40, combining in a fan-fold arrangement the segments 40a-d of the pouch. It can be advantageous to use material for at least one wall of the pouch that will retain a crease, to structurally guide folding of the pouch. Using material with such a feature can also be advantageous by visually indicating the intended fold lines, for with a material as thin as that which can be used for device 15 and with a pouch that is not much larger than the size of many hands, knowing where the folding should take place can encourage proper, faster folding. This takes into account, among other things, that while the device encourages proper folding, it cannot resist improper folding.

While not shown here, the invention can advantageously include a thin, though relatively stiff interfacing in lower segment 40d, affixed either to its front or back, though affixing to its front can be preferred as it can discourage billowing of the pouch when it is being folded. Such interfacing can fill most of the length and width of segment 40d and stop just below bottom crease 45c, thereby providing a break or pivot point that can help guide the intended fold at such location. Such interfacing can also extend just over crease 45c to reinforce it as a fold. Another alternative entails only using a narrow piece of interfacing at the fold and a centimeter into each adjoining segment.

It should be noted that the center of gravity of device 15 is not directly below a point half-way between first location 74a and second location 74b, as might be expected. While, in this way, the strap can be seen to be off-center, for a device of this size and for this purpose, the extent of being off center is not substantial relative to the benefits that this deign can facilitate, such as quick folding and a compact and unified device when it is stowed.

Normally a wide storage device that is designed to be folded more than simply at a medial vertical line is likely to require inward folding of segments serially from each side. While such a series of folding is not necessarily bad for the applications discussed here, it can be more difficult to accomplish, especially with one hand, and can require substantially stiffer pouch segments, resulting in a bulkier stowed device. Devices of the invention that comprise an offset, asymmetrical arrangement are able to be folded in a series of side-to-side folds which in the settings typical of the applications discussed here can be much easier to do.

FIG. 1B shows device 15 with all of the pouch segments 40a-d folded up. The strategic location of pivot point 47a can be seen, located along top crease 45a.

Also apparent is the advantageous integration of zipper 80. As the zipper slider is the thickest component of the pouch, here the effect of this thickness on the thickness of the stowed device is reduced by folding the pouch without covering the slider. Also, because the zipper is set at a bias and the device can be stowed with the zipper at opened end 81a, the zipper teeth component folds more easily and compactly, as an open zipper is easier to fold and the angle at which the zipper is set minimizes the extent of zipper teeth overlapping zipper teeth.

FIG. 1B also shows first axis 27a and second axis 27b, at which the device 15 and its pouch 40 are to be folded side-to-side. While the crease retaining capability of the fabric used to construct the pouch provides some folding guidance her as well, also significant is the folding memory of the material used to construct the case, as well as the design structure of the device that encourages an alignment of the two ends of the strap, one over the other, as the device is toggled to its stowed state.

As shown in FIG. 1C, left section 20a of the cover mechanism has been folded over, left to right, creating said alignment of the strap ends. Also, edge left 24c has become a pivot point for the last fold of the device, namely right section 20c folding right-to-left. It should also be noted that these two side-to-side folds of the cover also folds the pouch.

FIG. 1D shows device 15 fully stowed. With the case closed, it is wrapped around the folded pouch. It does create a top portal 68a and bottom portal 68b, which provide a very limited view of the folded pouch.

FIG. 1D also shows that when closed the device is compact and unified, in that it is small with a trim profile and presents a snagging hazard comparable to that of a standard luggage ID tag.

FIG. 1E shows a clip 90 which is a device for attaching storage device 15 to a pants belt, as an alternative to strap 70. It comprises a front 92a, a back 92b, and a top 92c, and an engagement space 91 is defined by these structures to receive a belt. The clip also comprises a back surface 93 at which it is to be affixed to outside 26 of cover mechanism 20 at its middle section 20b. A configuration of the storage device with clip 93 can better meet the needs of someone who has reason to go through a security checkpoint but does not have reason to carry a briefcase, suitcase, or the like.

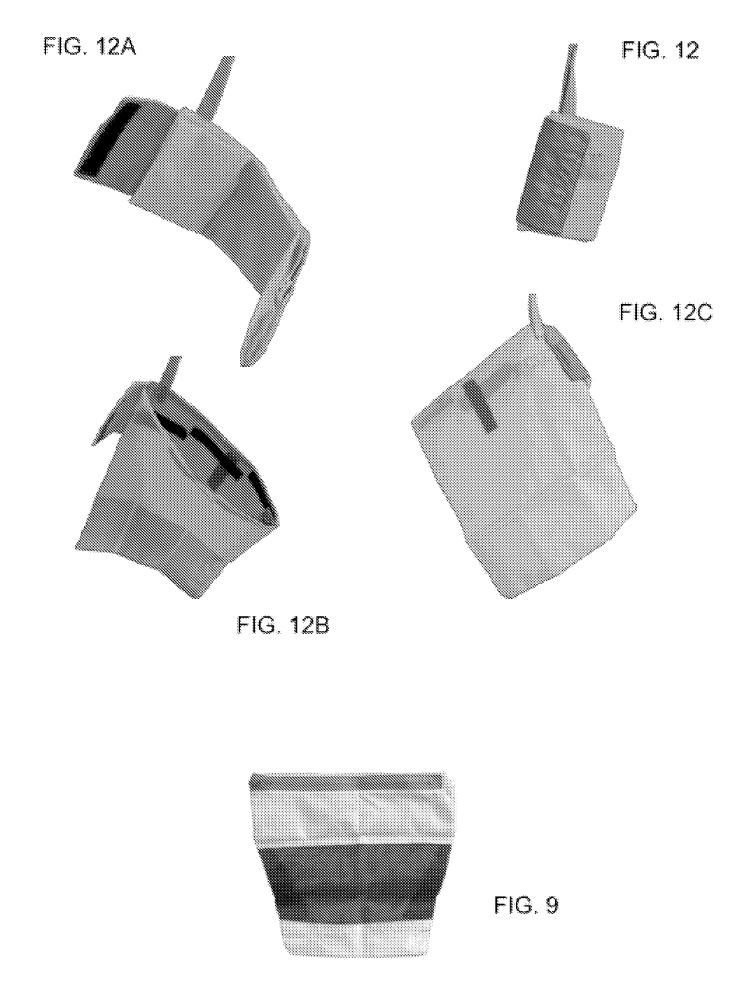

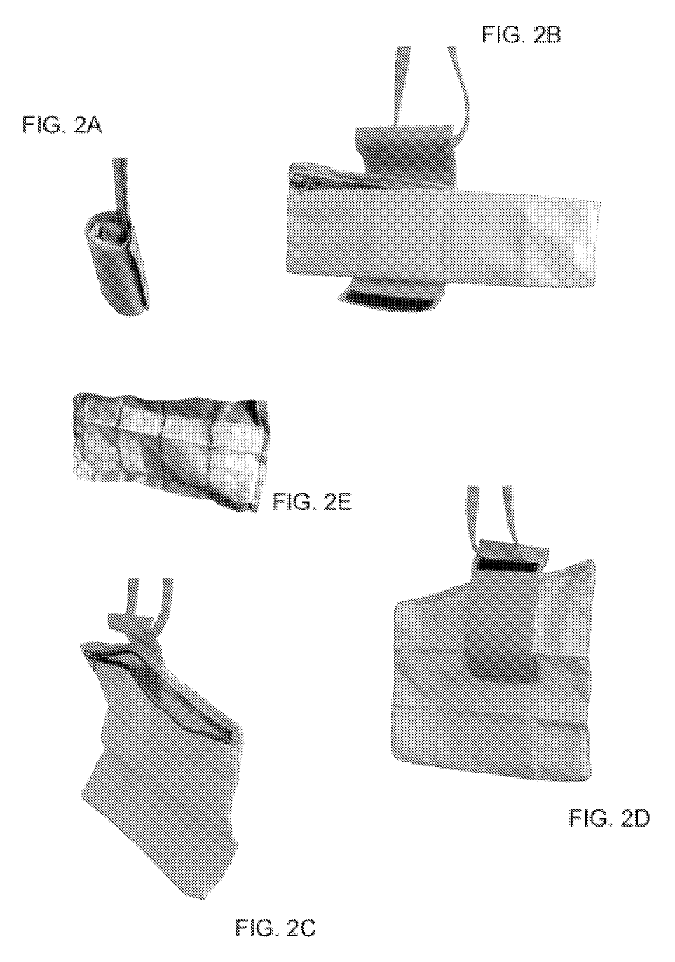

FIGS. 2-2E show views of a folding device with an offset zipper and bottom-up roll cover. Note than in FIG. 2 and FIG. 2A, in which the embodiment is shown in its collapsed state, the two strap ends, of the strap that is used to connect the device to the travel case, are attached to the device's cover, and wrapped within it, so as to be immediately proximate to each other. As the device is shown being deployed in FIGS. 2B-2C, the straps are released to form a stability-enhancing triangle, described above. As an aid to keep the straps together when the device is being collapsed and is secured in that state, a small flap (the material above where the straps are connected to the device's case) was formed to fold over so as to make a sandwich of portions of the strap, with the flap and a proximate portion of the case located above and below the straps. As with certain other embodiments of the invention, the orientation of the strap to the rest of the device changes when the device is taken from its closed state to its deployed state.

FIG. 2E shows a portion of the inside front surface of the pouch. This drawing highlights the focused use of interfacing to promote the intended functioning of the device while minimizing its collapsed thickness. The fusible interfacing has been affixed to the pouch using heat-set glue and sewing. The pouch has four vertical sections for folding side-to-side and the interfacing has been affixed as four pieces, one for each section. While in the embodiment shown in FIGS. 1-1C the interfacing stops at the horizontal fold line, in this embodiment the interfacing extends above the fold line enough to help set the crease in this material so as to promote the ready folding of the pouch. For this purpose, it is not necessary to extend the interfacing up to the next fold line so as to cover the entire middle section of the pouch.

FIGS. 3-3C show views of a stuff bag with bottom-opening case. This bag is designed to be randomly folded, that is stuffed, into its case. The bag is attached via an intermediate cloth strip to the inside of the case so that the bag can be fully extended from the case. As an alternative the bag could be directly attached, such as by sewing, to the inside surface of the cover flap.

As with all of the embodiments shown here that are not permanently affixed to a travel case, the bag is deployed, used, and collapsed without having to alter the bags connection to the travel case.

The bag exits its case through an opening in the bottom of the case. The bag shown is made of 1.3 ounce ripstop nylon coated with Teflon®. If the bag were to come out of an opening at the tope of the case, the cover flap, which could flop down, could interfere with use of the bag. For a shorter flap, this might be less of a concern, and the objects of the invention could be met with this embodiment being flipped 180 degrees to locate the opening at the top. Here, however, a long flap is used to provide an unobstructed component of the case that can be easily imprinted or embroidered—even after the bag, with its case, has been manufactured.

While the strap attachment and the embodiment could be considered to form an awkward T shape, discussed above, the case here is preferably between one inch and 3 inches square, so this does not present the same problem as would be presented by a bag or case that is five or more inches along its top edge.

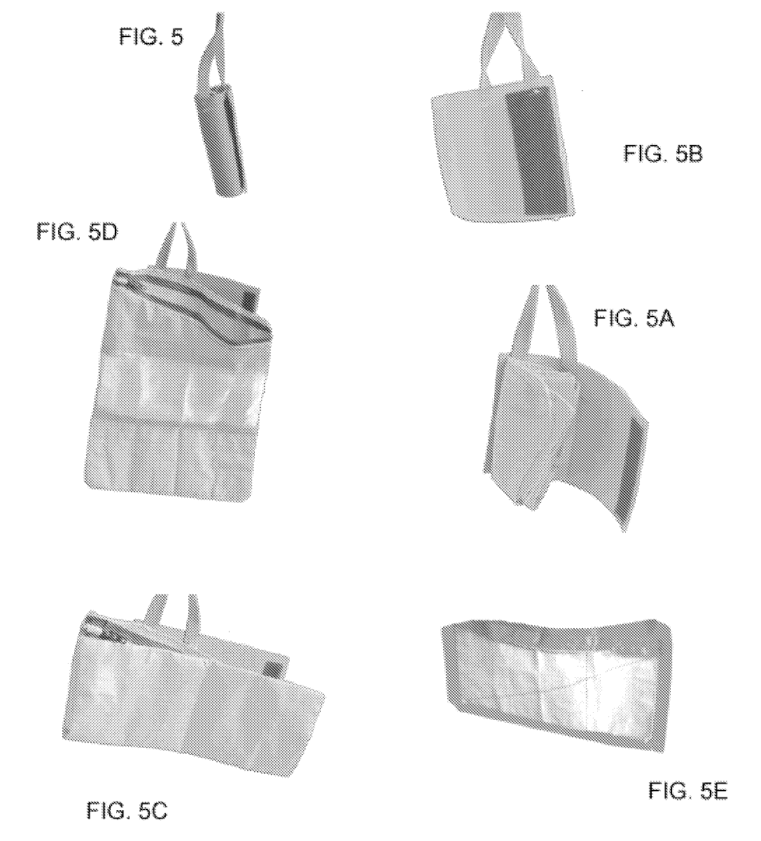

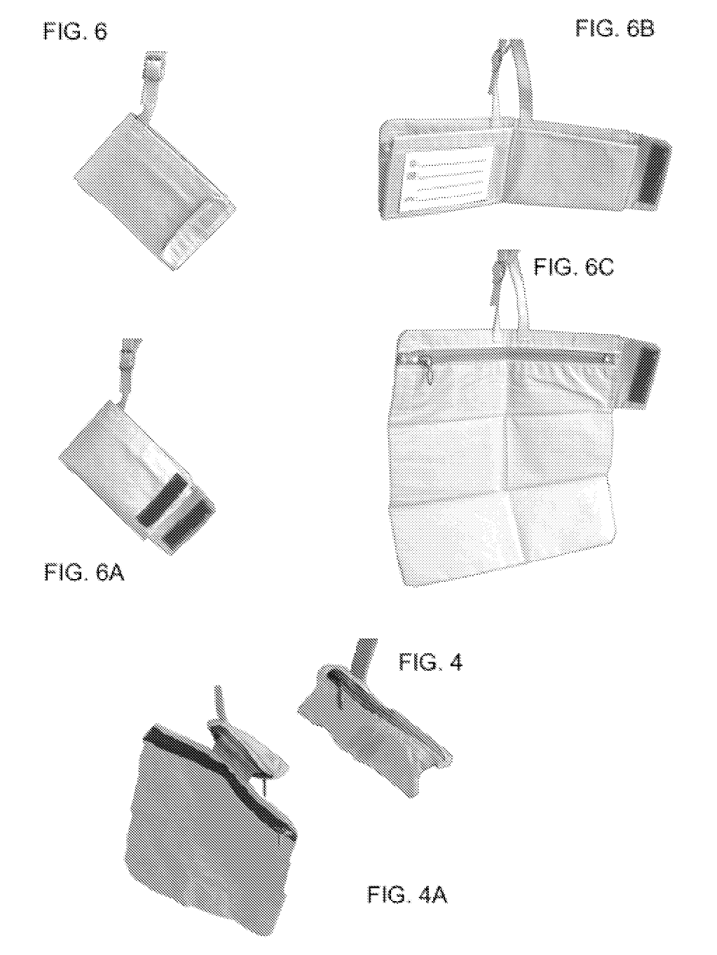

FIGS. 4-4A show views of a stuff bag with a thin material stuff case. The bag is attached to its stuff case via a strip of cloth.

FIGS. 5-5E show views of a folding pouch with an offset zipper and side-roll cover. This pouch, with its case, is similar to the one shown in FIGS. 2-2E. Here, the cover wraps around from the side, not up from the bottom. So, while the strap ends here also change their positions relative to each other as the device is deployed, a loose segment of the strap need not be enclosed within the case when the device is collapsed.

An example of the novel folding of the invention is shown in FIG. 5C. While the pouch is generally divided into three segments that run horizontally, the bottom two are formed to be smaller than the top one so that when the bottom two segments are folded up they do not cover the zipper's slider and pull.

Also, while not shown, the pouch is attached to its case not only along a portion of its top edge, but also by sewing along a portion of the pouch's top horizontal fold line at the back piece of the pouch. By attaching the pouch to the case at the specific area, the sewn seam acts as a pivot point when the pouch is being folded up, thereby promoting orderly folding of the pouch.

FIGS. 6-6C show views of a unified material folding device in a wallet-shaped form. This embodiment also incorporates an ID card which is hidden when the device is fully collapsed.

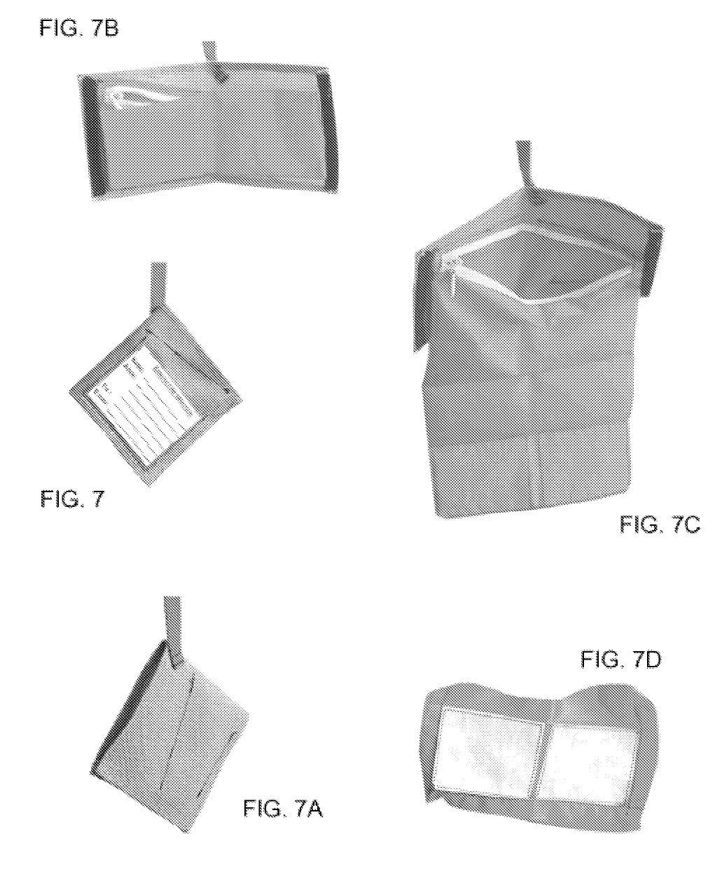

FIGS. 7-7D show views of a folding device with an offset zipper. When closed, the device hangs in a diamond-like orientation as to the travel case to which it is attached. Yet when the device is deployed, the strap is located just above the device's center line. This device also comprises a clear plastic window to hold an ID card. And, as can be seen in FIG. 7C, the device is attached to its case not only along portions of its top edge, but also at a fold line through the device's back piece.

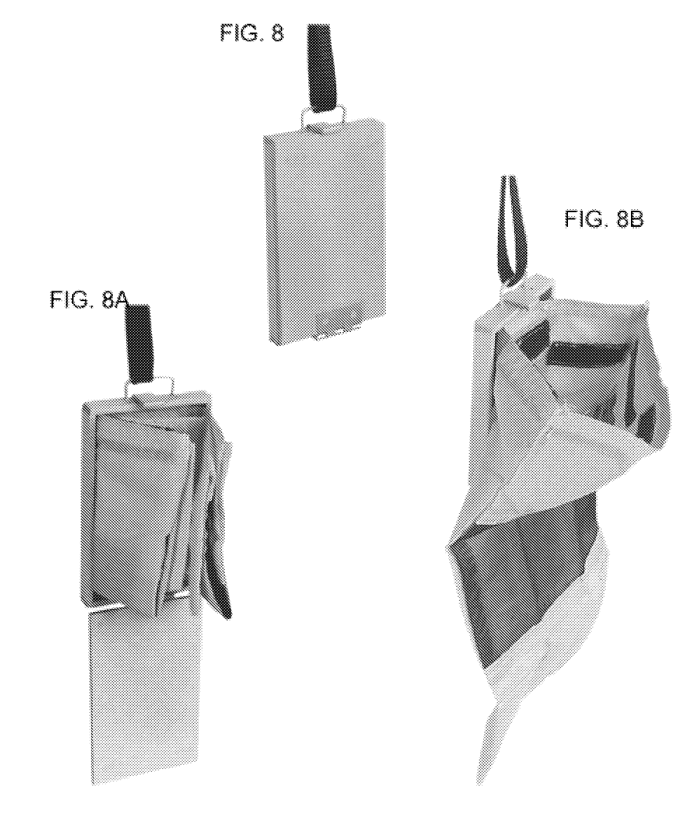

FIGS. 8-8B show views of a folding device with offset hook-and-loop strips and a rigid plastic case. The device also comprises a translucent mesh panel at its front.

FIG. 9 shows a view of a deployed folding pouch, standing alone, comprising alternative approaches to avoiding folding over the zipper slide. The pouch is divided into three segments running horizontally and two running vertically. The creases are heat set and no stiffener is used. While the zipper is not offset, the creases set in the pouch are offset. These offset creases promote folding of the pouch such that when the bottom two segments are folded up they do not cover the zipper. And, the vertical fold line is off center to the right, so that after the pouch is folded up and then side-to-side, the zipper's slider and pull are not covered.

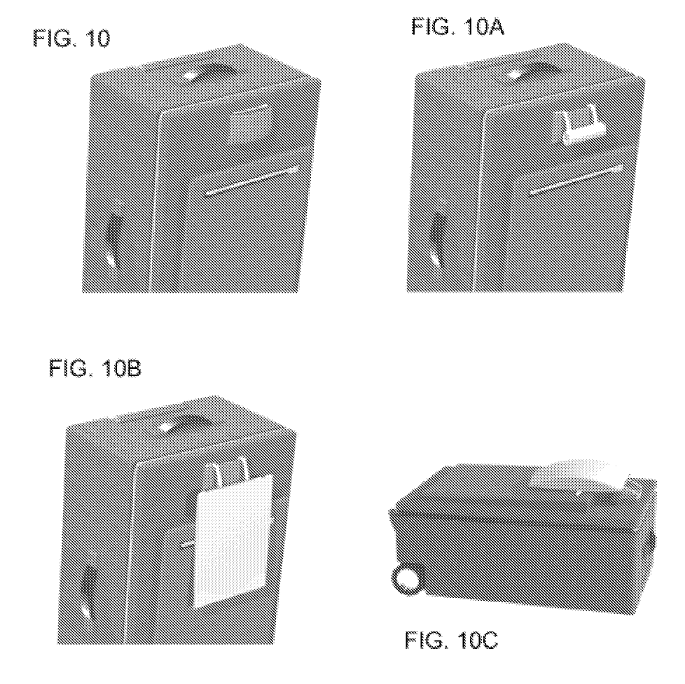

FIGS. 10-10C show a bag of the invention integrated with a rolling suitcase. The bag is stored in its collapsed state in a zippered case. While the zippered case shown here is affixed to the front of the suitcase, it can be affixed to other surfaces of the suitcase or inset with access provided from the outside of the suitcase at other surfaces of the suitcase. The bag has a zipper at its top edge and it is attached to the suitcase via two tethering straps, the straps being affixed at a surface inside of the zippered case. FIG. 10C shows the bag, with items having be placed inside and the bag being closed, as the suitcase and bag would be oriented when going through a scanner machine.

While there are known examples of small cases which are stored within pockets of larger cases and to which the small cases are tethered, such examples are lacking in relation to the present invention, and particularly to the embodiment shown in FIGS. 10-10C. In those known examples, the small cases, such as a change purse, are not collapsible. And they are not stored in a pocket sized primarily to contain them—that is, the change purse is connected via a tether to the general, main compartment of a pocketbook, so when the change purse is needed, it must be hunted out from within the main compartment.

While the embodiment shown in FIGS. 10-10C comprises a bag with a dedicated, integrated, zippered pocket directly accessible from the outside of rolling suitcase, the present invention anticipates any confined space serving a comparable function, such as an unzippered pocket, a set of straps, or a single wide strap affixed to the inside surface of a larger zippered pocket and dedicated primarily to holding the bag in its collapsed state.

It should be noted that no matter how or where in the suitcase the bag is stored when in its collapsed state, it is important that, if that storage space does hold additional items that are not affixed to the suitcase, provision be made to prevent those items from falling out when the entire case is going through the scanner machine process. A benefit of the bag being stored in a dedicated, externally accessible pocket is that the pocket's opening need not be closed other than to keep stored the collapsed bag.

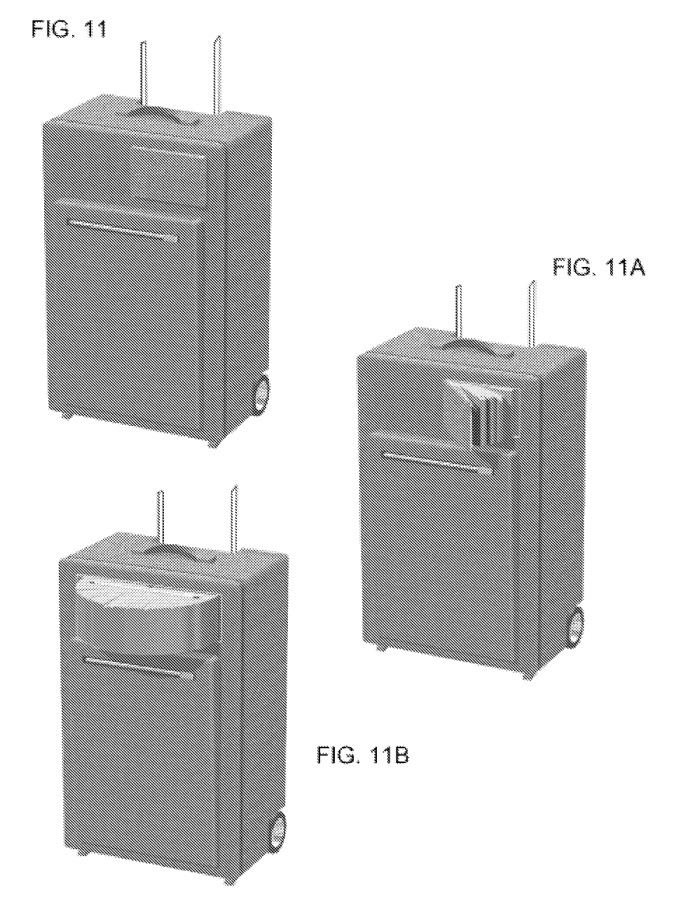

FIGS. 11-11B shows a bag of the invention more fully integrated with a rolling suitcase than the bag just described. The bag here is accessed for deployment via a zippered panel that is swung open to cause the bag to expand. The bag shown here is constructed of pleated material, generally in an accordion-like structure. The way in which the bag is connected to the suitcase, both when stored and when in use, is structurally substantial, as at least one face of the bag is completely affixed to the suitcase at all times. As shown here, and as aided by the pleat design, the bag can be collapsed for storage by simply swinging the covering panel shut and securing its zipper. The bag has its own closure device, a zipper on its top surface.

While expandable holding structures, affixed to the outside of suitcases, and which collapse to essentially zero storage volume, are known, they do not include a separate closing device, such as the zippers shown here. Such expandable structures offer non-closable top openings, such as for holding a water bottle or sports accessory.

A variation of the design shown here would comprise a similar panel which swings down to allow a pleated bag, or an unstructured bag, to be deployed. With such a drop-down panel, a simple non-gusseted bag could be used, similar to ones described above. Also, to help make the process of storing the bag quick and easy, the bag could be made of a stretchy material, such as Spandex™. This way, the bag could be constructed to lie flat when empty, but deployed, with a substantial portion of its back surface connected to the suitcase, and so would be very easy to put away by simply closing its covering, swinging panel—that is, there would be no loose fabric to be gathered up, yet the stretchy material would allow the bag to expand adequately to meet its purpose.

FIGS. 12-12C show a unified nylon folding device with an offset hook-and-loop closure device. The device does not comprise a discrete case, but rather is formed to provide the same enclosing function as the case described above. The nylon folding device has a tab combined with a strip of hook-and-loop material which joins to a complementary strip affixed to the back of the bag, as shown in FIG. 12C. As can be seen in FIG. 12B, a stiffener system, specifically fusible interfacing, has been affixed to the inside face of the front piece of the bag. Also, a portion of the strap used to attach the bag to a travel case is shown.

The pouch is formed with fold lines that divide it into nine segments, providing some structure for an ordered folding—up twice and then to the side twice. While the stiffener system runs across all of the bottom pouch segments, the stiffener has been formed in three separate pieces so that when the bag is folded to the side, which are compound folds, the stiffener will not then be folded over and add to the bags thickness in its collapsed state.

1. A device for storing personal items—
a. formed to facilitate a toggling of it readily between a plurality of states, such plurality of states comprising deployed and stowed, and further formed to facilitate the creation of a unified region of secure engagement with a base object, the device comprising a plurality of parts, said plurality of parts comprising a unified cover mechanism and a collapsible pouch, wherein—
i. the unified cover mechanism is formed to facilitate a toggling of it readily between a plurality of states comprising open and closed, said cover mechanism comprising—
A. a latch, formed to facilitate a toggling of it readily between a plurality of states comprising unlatched and latched, and
B. an engagement mechanism, formed to facilitate the secure engagement, and
ii. the collapsible pouch is formed to facilitate a toggling of it readily between a plurality of states, comprising unfolded and folded, and to securely hold an item, said pouch comprising—
A. a potential plurality of pouch regions,
B. a potential plurality of pouch segments,
C. a body, comprising a variable internal storage potential capable of receiving said item,
D. a front wall and a back wall, said front wall comprising a left edge and a right edge and a distance there between, a top edge and a bottom edge and a distance there between, said walls each comprising a potential plurality of wall regions which can be created by causing portions of the pouch to be overlapped and a potential plurality of wall segments which can be formed by creating wall regions by folding the pouch, wherein said front and back walls cooperate to provide substantial definition of the storage potential between said front and back walls, and wherein the storage potential of the pouch is substantial when the pouch is unfolded and generally insubstantial when the pouch is folded,
E. an opening through which practical access to said storage potential is provided, comprising a first end and a second end distal to said first end when the device is deployed, and
F. a closure mechanism formed to facilitate a toggling of it readily between a plurality of states, such plurality of states comprising closed and open, wherein open comprises any state which is not-closed, said closure mechanism comprising an X end, a Y end operationally distal to said X end, and at least one face, each of which at least one face comprises a plurality of face segments, said closure mechanism being incorporated into the pouch proximate to the opening such that when said closure mechanism is closed it discourages an inopportune movement through the opening of an item of a predetermined minimum size.
b. Wherein—
ii. while said secure engagement of the device and the base object is maintained and while the device is pending therefrom, the toggling of the device can proceed—
A. from stowed to deployed, such toggling comprising causing the cover mechanism to be open and the pouch to be unfolded, thereby allowing an item of a substantial size, which size is within a range of predetermined substantial sizes, to be placed through the opening, subject to the closure mechanism being open, and into the storage potential where it will tend to remain with benefit of gravity even in an absence of the closure mechanism being closed thereafter, and
B. from deployed to stowed, such toggling comprising causing the pouch to be folded and the cover mechanism to be closed, and after the cover is closed the latch to be latched, and.
iii. the toggling of the pouch from unfolded to folded results in—
A. a reduction in the distance between the left and right edges of the pouch, and
B. an opening-reduction, comprising a reduction in the distance between the first end and the second end of the opening, and
iv. when the pouch is in its folded state it comprises at least one multi-layer pouch section, comprising a layering of a plurality of regions of the pouch, and when the cover mechanism is closed and the latch latched, the pouch is maintained in said folded state and said device is compact and unified.

2. The device of claim 1, wherein the toggling of the device from deployed to stowed further results in a reduction in the distance between the top and bottom edges of the pouch.

3. The device of claim 2, wherein, of the two reductions in distances between edges of the pouch, at least one of said reductions is executed along a generally straight line effectively engaging the front wall at its top and bottom edges or at its right and left edges.

4. The device of claim 3 wherein the toggling of the device from deployed to stowed comprises a regular folding of the pouch, said regular folding comprising—
a. an at least one up-fold, whereby at least one generally straight fold line is created that effectively engages the left edge and the right edge of the pouch, and
b. an at least one side-fold, whereby at least one generally straight fold line is created that effectively engages the top edge and the bottom edge of the pouch.

5. The device of claim 4,
a. additionally—
ii. the case further comprising two open-dimensions, an open-height dimension and an open-width dimension,
iii. the pouch further comprising two variable size dimensions, a pouch-height dimension, related to said open-height dimension, and a pouch-width dimension, related to said open-width dimension,
iv. the toggling of the device between being deployed and being stowed comprising a series of steps, such series of steps comprising a series of folds which comprise said regular folding,
b. wherein the toggling of the device from deployed to stowed further comprises, prior to the case being toggled to its closed state, the pouch undergoing a number of folds from said series of folds so as to cause a reduction in an effective dimension of the pouch, such that while said effective dimension had been larger than the related open-dimension of the case, it becomes generally not larger than said related open-dimension.

6. The device of claim 5, wherein said reduction in the effective dimension of the pouch can be caused by a closing of the case component.

7. The device of claim 6 wherein said reduction in the effective dimension of the pouch requires said closing of the case component.

8. The device of claim 4, wherein, when causing the toggling of the device from deployed to stowed, the series of folds comprises completing all of the at least one up-fold of the pouch without interruption for a side-fold and completing all of the at least one side-fold of the pouch without interruption for an up-fold.

9. The device of claim 1, further comprising an appendage formed to facilitate the secure engagement with the base object, said appendage comprising a first end and a second end, each such end being effectively affixed to the cover mechanism at a first location and a second location, respectively, and further comprising an inner surface, said inner surface comprising a first surface proximate to the first end of the appendage and a second surface proximate to the second end of the appendage, wherein when the device is stowed the first surface is opposed to the second surface and the distance between said surfaces is smaller than when the device is deployed.

10. The device of claim 9, wherein when the device is deployed the distance between said ends is larger than when the device is stowed.

11. The device of claim 10, wherein when the device is deployed the first and second surfaces of the inner surface are other than opposed to each other.

12. The device of claim 1, the cover mechanism further comprising an upper edge and the device further comprising an appendage formed to facilitate the secure engagement with the base object, said appendage comprising an end, said end being effectively affixed to the cover mechanism proximate the upper edge at a first location, wherein, with the device pending from the secure engagement and with benefit of gravity, a segment of the upper edge proximate the first location suggests an angle as to the ground when the device is stowed, and when the device is deployed said segment of said upper edge proximate said first location suggests a different angle as to the ground.

13. The device of claim 5, the device further comprising when it is stowed a plurality of layers of materials and a thickness of each said layer, a first net thickness comprising an aggregate of the thicknesses of all of said plurality of layers stacked above and below an area of a thickest dimension of the closure mechanism, and a second net thickness comprising an aggregate of the thicknesses of all of said plurality of layers stacked above and below one of the potential plurality of wall segments of the front wall that is adjacent to said area of thickest dimension of the closure mechanism, wherein the second net thickness is larger than the first net thickness.

14. The device of claim 1, the cover mechanism further comprising an upper edge and the device further comprising a connecting component formed to be affixed to the case at least one affixing point proximate said upper edge and to connect to the base object to facilitate the secure engagement of the device with the base object, wherein when the device is deployed there is established an average point along the upper edge that represents a location average of all of said at least one affixing points, and the mass of the deployed device to one side of the average point is not equal to the mass of the deployed device to the other side.

15. The device of claim 5 wherein at least one fold of said series of folds is a regular fold along an axis exhibiting at least one readily discernible indicator that said at least one fold was executed the immediately prior instance that the pouch was folded.

16. The device of claim 1 wherein the device is permanently affixed to a travel case comprising at least one case wall, and wherein the unified cover mechanism further comprises and at least a portion said at least one case wall.

17. The device of claim 1 wherein the unified cover mechanism at least partially defines a limited volume when it is open and toggling the device from deployed to stowed comprises stuffing the pouch into said volume.

18. The device of claim 5 further comprising a stiffener arrangement comprising at least one stiffener wherein the at least one stiffener is foldable.

19. The device of claim 6, further comprising an appendage formed to facilitate the secure engagement with the base object, said appendage comprising a first end and a second end, each such end being effectively affixed to the cover mechanism at a first location and a second location, respectively, and further comprising an inner surface, said inner surface comprising a first surface proximate to the first end of the appendage and a second surface proximate to the second end of the appendage, wherein when the device is stowed the first surface is opposed to the second surface and the distance between said surfaces is smaller than when the device is deployed, when the device is deployed the distance between said ends is larger than when the device is stowed and the first and second surfaces of the inner surface are other than opposed to each other.

20. The device of claim 19 wherein the weight of the device, itself, is less than 140 grams.
